(19) United States
(12) Patent Application Publication
(10) Pub. No.: US 2026/0092864 A1
(43) Pub. Date: Apr. 2, 2026

(54) INTERFEROMETER SYSTEM AND METHOD

(71) Applicant: James Alan Monroe, College Station, TX (US)

(72) Inventor: James Alan Monroe, College Station, TX (US)

(21) Appl. No.: 19/342,377

(22) Filed: Sep. 26, 2025

Related U.S. Application Data
(60) Provisional application No. 63/700,485, filed on Sep. 27, 2024.

(51) Int. Cl. G01N 21/45

(52) U.S. Cl. CPC G01N 21/45

(57) ABSTRACT

An interferometer system and method capable of simultaneous refractive index and thermal defocus determination is disclosed. The system incorporates a collimating light that is spatially filtered, and expanded, and passed through a wedged shear plate and focused on a sample of known thickness. The focused light is retroreflected through the focusing optic, and reflected off the shear plate. The retroreflected light is reflected off the wedged shear plate forming two wavefronts. Where the two wavefronts spatially overlap, an observation screen is used to view the interference fringes formed. The focus optic is translated on a linear stage and the interferogram is used to determine the retroreflective condition for both the front and back surfaces of the sample. The system/method may be advantageously applied to a wide variety of optical lens materials, including but not limited to the characterization of infrared (IR) lens materials.

### CROSS REFERENCE TO RELATED APPLICATIONS

### Provisional Patent Applications

This application claims benefit under 35 U.S.C. § 119 and incorporates by reference United States Provisional Patent Application for INTERFEROMETER SYSTEM AND METHOD by inventor James Alan Monroe, filed with the USPTO on 2024 Sep. 27, EFSID 67361389, No. 63/700,485, with serial confirmation number 5384, docket AZTES-0107.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to interferometers as applied to the determination of refractive index and thermal defocus determination in an optical material. Specifically, and without limitation, this determination of refractive index and thermal defocus determination may apply advantageously to optical lens materials and to characterizing infrared (IR) lenses and lens assemblies in particular.

### PRIOR ART AND BACKGROUND OF THE INVENTION

### Refractive Index

In optics, the refractive index (or refraction index) of an optical medium is a dimensionless number that gives the indication of the light bending ability of that medium.

The refractive index determines how much the path of light is bent, or refracted, when transitioning from one material or medium to another. This is described by Snell's law of refraction, n1 sin θ1=n2 sin θ2, where θ1 and θ2 are the angle of incidence and angle of refraction, respectively, of a ray crossing the interface between two media with refractive indices n1 and n2. The refractive indices also determine the amount of light that is reflected when reaching the interface, as well as the critical angle for total internal reflection, their intensity (Fresnel equations) and Brewster's angle.

The refractive index, n, can be seen as the factor by which the speed and the wavelength of the radiation are reduced with respect to their vacuum values: the speed of light in a medium is v=c/n, and similarly the wavelength in that medium is λ=λ0/n, where c is the speed of light in a vacuum, λ0 is the wavelength of that light in vacuum, and n is the refractive index of the medium.

The measurement of refractive index applies across the full electromagnetic spectrum, from X-rays to radio waves. The refractive index of a material or medium varies with wavelength, known as dispersion. This causes light to split into constituent colors or frequencies when refracted. For most materials the refractive index changes with wavelength by several percent across their transparent spectrum. Consequently, refractive indices for materials reported using a single value for n must specify the wavelength used in the measurement. Materials transparent to electromagnetic radiation also exhibit temperature dependent changes in refractive index. This temperature dependence is known as dn/dT where dn is the change in refractive index and dT is the change in temperature. Values of dn/dT are material dependent and can be positive or negative and be small or large in magnitude. The larger the magnitude, the greater the temperature effect. Therefore, characterizing the refractive index across spectral bands and temperature are important for the successful design of refractive optics.

### Thermal Defocus

Thermal defocus is the change in the focus of a lens due to temperature changes. It is caused by changes in the index of refraction with temperature, dn/dT, and thermal expansion of the lens material. While thermal defocus can affect all optical systems, it is especially noticeable in imaging systems that require the use of materials with high dn/dT. For example, the mid- to far-infrared spectral range requires the use of infrared transparent materials that have large dn/dT magnitudes.

Thermal defocus of a single lens can be quantified using the coefficient of thermal defocus, δ, which is a combination of material properties:
Thermal expansion coefficient: The expansion of the lens material with temperature that changes lens geometry,
Change in index of refraction: The change in the index of refraction with temperature, dn/dT, and
Absolute Refractive index: The index of refraction in a vacuum.

The change in the lens element's focal length, Δf, is equal to δ times the focal length, f, times the change in temperature, ΔT. This focal length can grow, positive change, or shrink, negative change, depending on the values of material properties. The thermal defocus of optics with multiple lens elements is dictated by the combined thermal defocus contribution of individual lens elements.

Athermalized optics can be fabricated by proper selection of lens materials, lens geometries and lens housing materials that cancel out thermal defocus effects when combined. Athermal systems don't require electronics to adjust the focus as the temperature changes.

### Numerical Aperture (NA)

Numerical aperture (NA) is a lens's light gathering capability and is a key factor in determining the performance of an objective lens. It is defined by the equation NA=n*sin θ, where:
n: The refractive index of the medium
θ: The half-angle of the cone of light exiting the lens pupil

A higher NA means a lens has a greater resolving power a brighter image, but a shallower depth of focus. Refractive index is directly proportional to the numerical aperture and therefore must be known for proper optic design.

### Defense Application of Refractive Index and Thermal Defocus

A robust and reliable United States based supply chain for infrared (IR) optic lens materials is essential to produce optics that perform in critical defense areas. Currently, the IR lens material supply chain is constrained by a lack of batch-level certification of refractive index properties. Furthermore, optic performance is rarely certified for performance specifications across the operating temperatures of many military systems. As a result, a high dollar EO may be manufactured and procured only to find out it does not meet government requirements. To overcome this issue, bulk refractive index properties of IR lens materials and thermal defocus must be measured in production.

The current industry standard for refractive index measurement is the minimum deviation test that rotates a sensor around an IR material prism. This method is cost prohibitive due to high sample preparation and third-party testing costs Thermal defocus is currently evaluated by assessing modulation transfer function (MTF), a measure of optic performance, across temperature on measurement equipment that is prohibitively expensive for most manufacturers. There is a need for rapid and economical refractive index and thermal defocus testing of IR transparent materials and IR lens assemblies to ensure the security and reliability of the IR-EO supply chain.

### INCORPORATED REFERENCES

The following prior art documents are included by reference in this patent application:
[1] Malacara, D. (2007) Optical Shop Testing, Third Edition. John Wiley & Sons, Inc.
[2] Monroe, J. A. et al. (2024) Athermalizing mounted doublets with ALLVAR alloys. SPIE Proceedings, 13131-18.
[3] Coppola, G. et al. (2003) Method for Measuring the Refractive Index and the Thickness of Transparent Plates with a Lateral-Shear, Wavelength-Scanning Interferometer. Applied Optics, 42, 3882-3887.
[4] SCHOTT Technical Information: Optical Properties of ZERODUR, November 2007.

### DEFICIENCIES IN THE PRIOR ART

Prior art systems to determine refractive index and thermal defocus typically suffer from the following characteristic deficiencies:
High cost.
Low supply chain reliability.
   To date the prior art has not fully addressed these deficiencies.

### OBJECTIVES OF THE INVENTION

Accordingly, the objectives of the present invention are (among others) to circumvent the deficiencies in the prior art and affect the following objectives:
(1) Provide for a system and method to determine the refractive index and thermal defocus of IR materials at low cost.
(2) Provide for a system and method to determine the refractive index and thermal defocus of IR materials without depending on supply chain reliability.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

To overcome the high-cost systems and third-party testing, the present invention discloses a novel shear plate interferometer for refractive index measurement and thermos-optic coefficient determination. The main advantages are:
(1) using flat polished samples for homogeneity mapping and batch-to-batch traceability,
(2) Bulk measurement of refractive index properties,
(3) Economical capital equipment and operational cost compared to the state of the art,
(4) rapid sample and optic alignment and measurement,
(5) direct measurement of refractive index that is refractive index value agnostic, and
(6) the dual use of the same system for thermal defocus testing of IR-EO assemblies.
   The use of flat specimen geometries drastically cuts overhead, sample preparation, and testing lead time compared to prisms and wedges used in conventional minimum deviation measurements and the dual use enables end-to-end validation of input materials and output optics for IR-EO manufactures and system integrators.

### BRIEF DESCRIPTION OF THE DRAWINGS

For a fuller understanding of the advantages provided by the invention, reference should be made to the following detailed description together with the accompanying drawings wherein:

FIG. 1 illustrates a block diagram depicting a prior art refractive index measurement (RIM) system;

FIG. 2 illustrates a block diagram depicting a prior art optic aberration measurement (OAM) system;

FIG. 3 illustrates a block diagram depicting a generalized present invention embodiment depicting a dual-use refractive index and thermal defocus measurement (RID) system;

FIG. 4 illustrates a block diagram depicting a generalized present invention embodiment depicting a dual-use refractive index and thermal defocus measurement (RID) system wherein the ROA and EUT/SUT are movable in the z-axis under automated computer control based on sensor feedback from the IOS;

FIG. 5 illustrates a block diagram depicting a generalized present invention embodiment depicting a dual-use refractive index and thermal defocus measurement (RID) system wherein the ROA is fixed in the z-axis and the EUT/SUT are movable in the z-axis under automated computer control based on sensor feedback from the IOS;

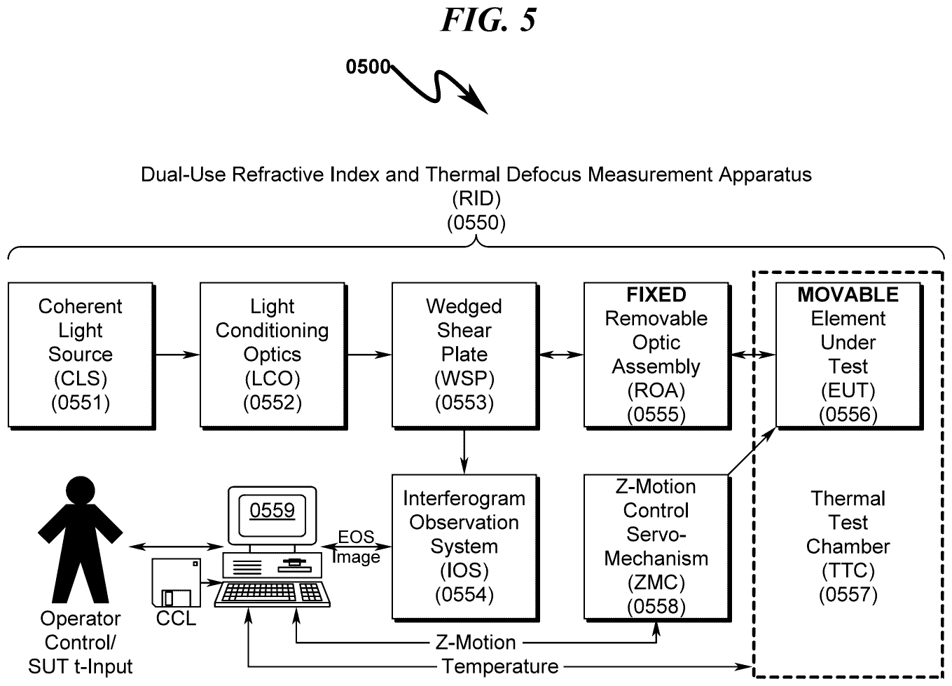

FIG. 6 illustrates a block diagram depicting a generalized present invention embodiment depicting a dual-use refractive index and thermal defocus measurement (RID) system wherein the EUT/SUT are fixed in the z-axis and the ROA is movable in the z-axis under automated computer control based on sensor feedback from the IOS;

FIG. 7 illustrates a wedged shear plate (WSP) and interferogram observation system (IOS) useful in some preferred invention embodiments;

FIG. 8 illustrates a refractive index measurement configuration of a presently preferred invention system embodiment;

FIG. 9 illustrates a thermo-optic coefficient measurement configuration of a presently preferred invention system embodiment;

FIG. 10 illustrates the dual-use functionality of the present invention as applied to a material refractive index (MRI) determination and a thermo-optic coefficient (TOC) determination;

FIG. 11 illustrates visual operations depicting a method for determining index of refraction measurement and depicts the interferogram analysis procedure for material refractive index (MRI) determination using an exemplary present invention system embodiment;

FIG. 12 illustrates visual operations depicting a method for determining thermo-optic coefficient measurements and depicts the interferogram analysis procedure for thermos-optic coefficient (TOC) determination using an exemplary present invention system embodiment;

FIG. 13 illustrates a flowchart illustrating a preferred exemplary invention shear plate interferometer refractive index method;

FIG. 14 illustrates a flowchart illustrating a preferred exemplary invention shear plate interferometer thermal defocus method;

FIG. 15 illustrates a flowchart illustrating a preferred exemplary invention shear plate interferometer thermal defocus method; and

FIG. 16 illustrates a flowchart illustrating a preferred exemplary invention interferometer thermal defocus method.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an INTERFEROMETER SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Digital Computing Device (DCD)

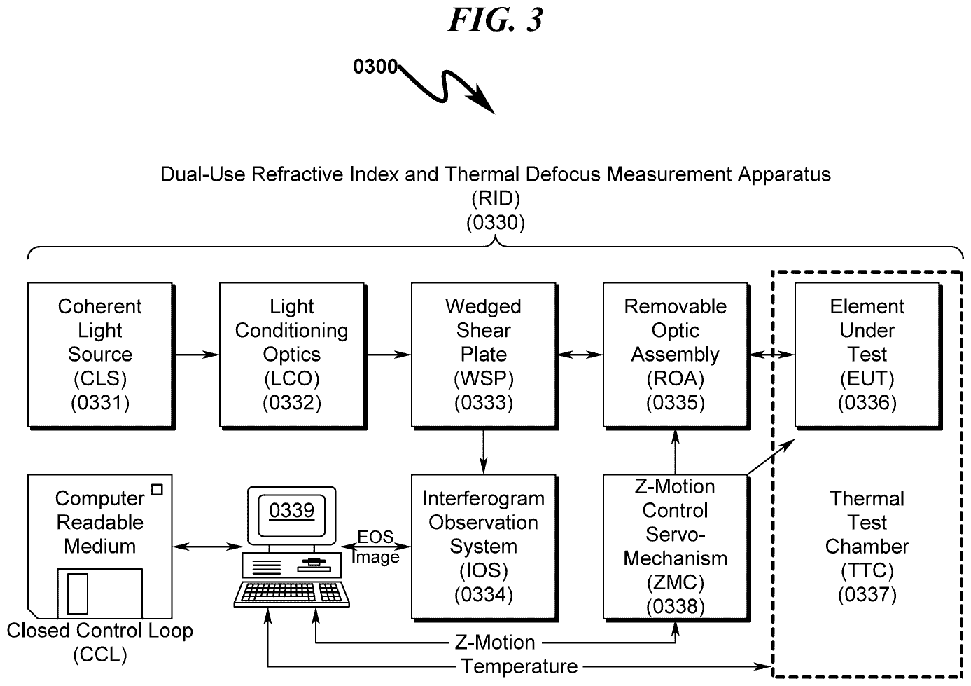

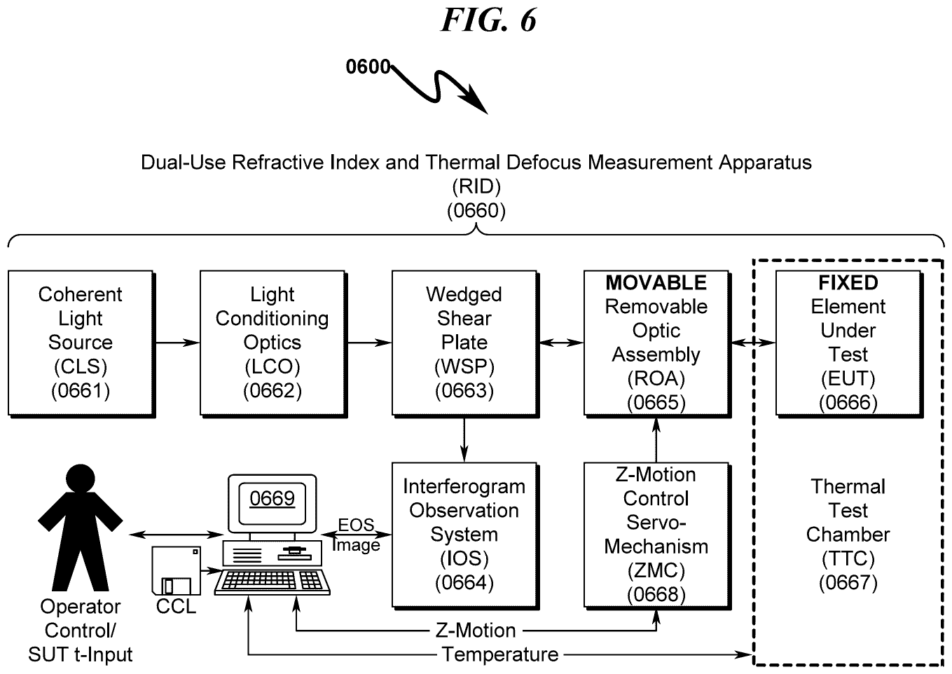

A preferred exemplary embodiment of the present invention method as depicted in FIG. 3 (0300)-FIG. 6 (0600) may include a digital computing device (DCD) (0339, 0449, 0559, 0669) executing instructions from a tangible machine-readable medium to implement a closed control loop (CCL) that interacts with the interferogram observation system (IOS) (0334, 0444, 0554, 0664) and Z-motion control servomechanism (ZMC) (0338, 0448, 0558, 0668) to control the distance between the removable optic assembly (ROA) (0335, 0445, 0555, 0665) and the element under test (EUT) (0336, 0446, 0556, 0666) based on image data obtained from a electro-optic sensor (EOS) within the IOS (0334, 0444, 0554, 0664).

The CCL may also control the temperature environment in which the EUT (0336, 0446, 0556, 0666) operates via control inputs and temperature outputs from the thermal test chamber (TTC) (0337, 0447, 0557, 0667) to both stabilize the temperature environment and select between different operational temperatures of the EUT (0336, 0446, 0556, 0666) and SUT.

### Z-Motion Control Servomechanism (ZMC)

The present invention may incorporate a linear z-motion control servomechanism (ZMC) that enables linear positioning of one or more components within the present invention. Specifically, the ZMC may incorporate motion controls for the removable optic assembly (ROA) and/or the element under test (EUT) and/or sample under test (SUT). The present invention anticipates that the ZMC may be configured based on application context to support independent movement for any combination of these system elements.

### Closed Control Loop (CCL)

The present utilizes a closed control loop (CCL) within the DCD to iteratively inspect interferogram observation system (IOS), adjust the distance between the removable optic assembly (ROA) and the element under test (EUT)/sample under test (SUT) using the z-motion control servomechanism (ZMC) to obtain proper focus and fringe patterns on the electro-optic sensor (EOS). In this manner, the delta-z positions and measurements on the system can be automated to produce results better than that which would be available using traditional manual z-position manipulation methodologies. It should be noted that the CCL also may control the temperature environment of the overall EUT/SUT and thus be able to standardize thermal stabilization procedures for the EUT/SUT testing that would eliminate the possibility of human error in these procedures.

### Overview (0300)-(0600)

FIG. 3 (0300)-FIG. 6 (0600) depict system block diagrams of a presently preferred invention system embodiment of the proposed shear plate interferometer for measuring refractive index. The system consists of collimated light that is spatially filtered, and expanded and passed through a wedged shear plate. The light transmitted through the shear plate is focused on a sample of known thickness, t. The focused wave front is retroreflected through the focusing optic, is reflected off the shear plate. The retroreflected light is reflected off both surfaces of the wedged shear plate forming two wavefronts sheared by a distance S. Where these two wavefronts spatially overlap, interference fringes are formed and viewed on an observation screen.

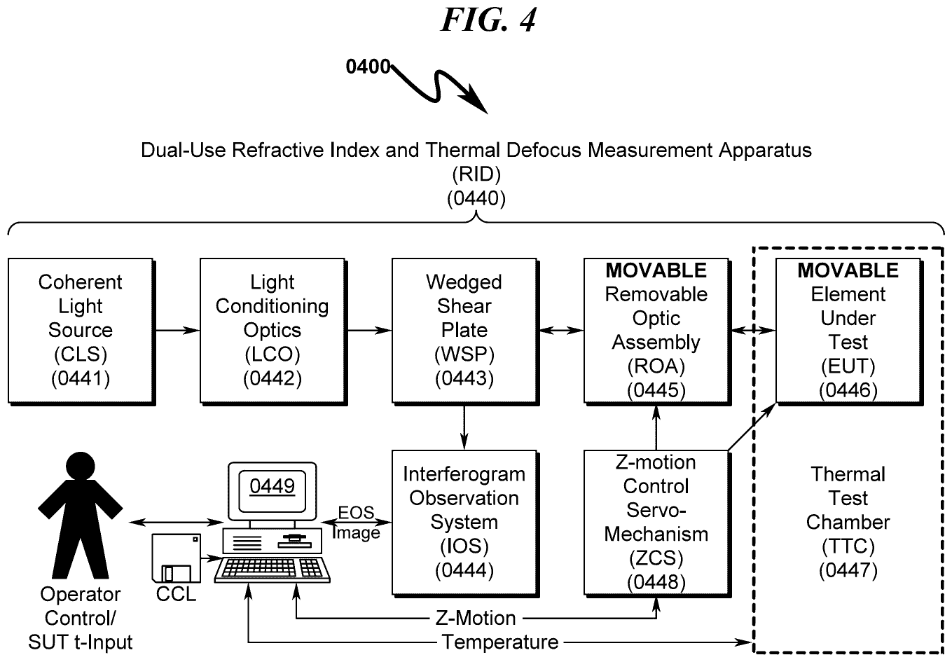

The focus optic is translated on a linear stage and the interferogram used to determine the retroreflective condition for both the front and back surfaces of the sample. For paraxial rays on a flat of thickness t, two such conditions exist; one at the sample's surface and one at t/n from the surface (see FIG. 4.39 in reference [1]).

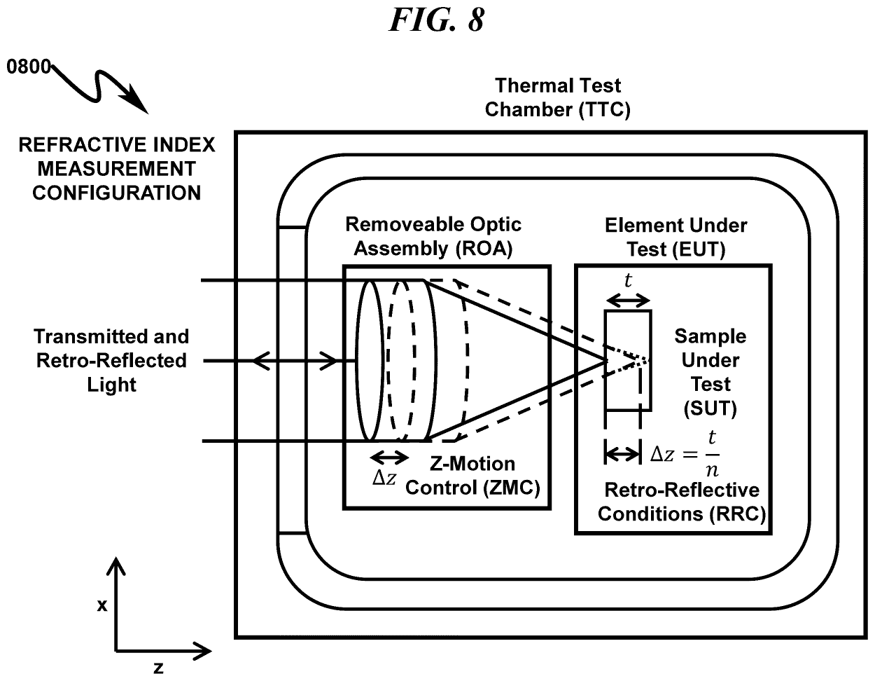

FIG. 8 (0800) depicts the method an operator uses to measure refractive index. First, the sample thickness is measured and then it is placed in the test apparatus. The wedge angle of the shear plate produces horizontal central fringes in the interferogram when at focus at either surface and angled central fringes when the system is outside or inside focus (reference [1]). The operator brings the system to focus on the sample's front surface by moving the focusing optic's position until horizontal fringes are observed. Fast Fourier Transform (FFT) analysis of the interferogram then refines the focus measurement to an uncertainty of λ/20 (reference [3]).

Multiple measurements can be collected in rapid succession, FFT analysis performed, and the results averaged automatically to produce sub-micron measurement uncertainty. The operator then moves the focusing optic to the second paraxial focus condition at a distance t/n from the sample's surface and the FFT analysis is repeated to determine the distance between retroreflective conditions, Δz. A simple equation, n=t/Δz, is used to calculate the index of refraction (reference [1]).

Focusing into a sample introduces overcorrected spherical aberration. However, the spherical aberration is directly related to t, n, and the focusing NA. The central portion of the interferogram maps the paraxial focus and the odd-order fit of the interference fringes maps the spherical aberration. The interference fringes from the back surface retroreflection provides refractive index information two ways: location of paraxial focus and amount of spherical aberration. Combining this information improves refractive index measurement accuracy and precision. Thicker samples, lower index materials, and shorter wavelengths will have a lower uncertainty. Preliminary analysis indicates that refractive index (?) uncertainties of +/−0.001 or less can be achieved for 5 mm thick high index Ge at 3 μm to 12 μm wavelengths of interest and ALLVAR has experimentally measured ZERODUR's refractive index at 1.541 for λ=632.8 nm (published value: 1.5407 in reference [4]).

### Prior Art Comparison

Table 1 compares the present invention interferometric solution to various index of refraction measurement techniques. It provides a comparison of size, cost, sample geometry, measurement depth, uncertainty sources, calculation and method for shear plate interferometry, minimum deviation, ellipsometry and prism coupling methods for index of refraction measurements.

TABLE 1

| | Optical | | | | | |
|---|---|---|---|---|---|---|
| | Bench | Cost | | Meas. | Uncertainty | Calculation/ |
| Method | Footprint | $1000 | Sample | Depth | Limit | Method |
| Interferometry | ¼ to ½ | ~$75 | Flat | ~mm | +/−0.0005 | Simple/ |
| | bench | | | | | Direct |
| Min. Deviation | Full bench | ~$300 | Prism/ | ~mm | +/−0.00001 | Complex/ |
| | | | Wedge | | | Direct |
| Ellipsometry | ¼ to ½ | ~$100 | Thin | Surface | +/−0.0005 | Complex/ |
| | bench | | Film | | | Indirect |
| Prism Coupling | ½ bench | ~$75 | Flat | ~μm | +/−0.0005 | Simple/ |
| | | | | | | Direct |

In addition to minimum deviation and the proposed interferometry, non-traditional methods such as ellipsometry and prism coupling are solutions. As discussed previously, minimum deviation is a high-accuracy method but is extremely expensive to implement. Next, ellipsometry is fairly easy to perform, but it is an indirect method that only measures surface or thin film properties which can vary significantly from the bulk material's refractive index. Lastly, prism coupling is simple to perform, low cost and direct, but it is limited to measuring low index materials because the prism must have a higher index than the material being measured. This limitation makes measuring materials like Ge and Si and with a calibrated standard reference prism exceedingly difficult.

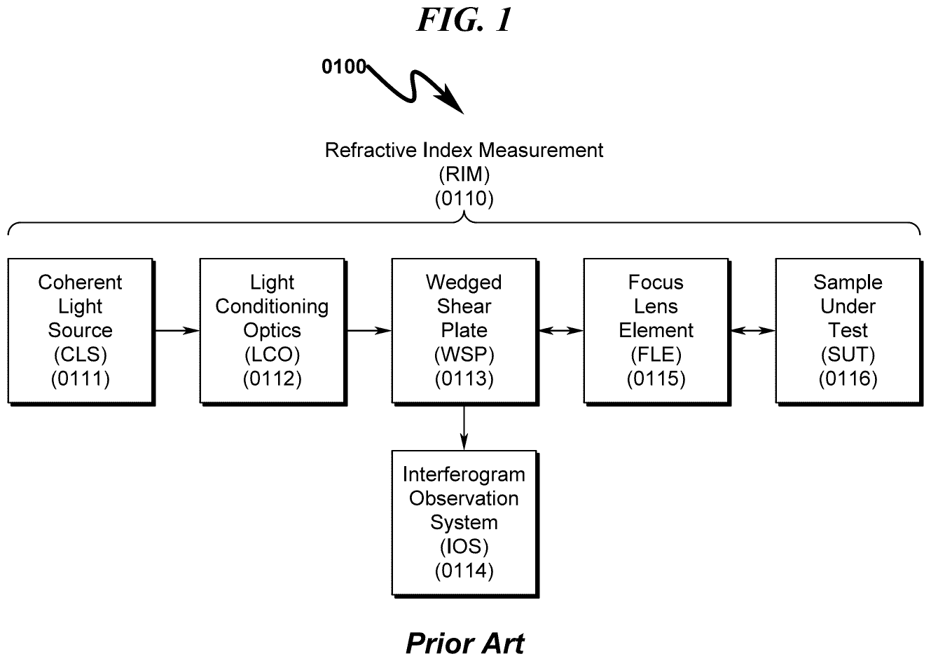

FIG. 1 (0100) depicts a block diagram of a prior art wedge shear plate system for refractive index determination. A coherent light source (CLS) (0111) generates light that is conditioned by light conditioning optics (LCO) (0112) in preparation for passing through a wedged shear plate (WSP) (0113). A focus lens element (FLE) (0115) then focuses light on a sample under test (SUT) (0116). The sample under test retroreflects light back through the focus lens element and off the two faces of the wedged shear plate. The light then enters an interferogram observation system. The interferogram pattern is then used to determine the retroreflective focus positions front and back surface of the sample under test. Knowing the sample's thickness and the distance between the two retroreflective conditions enables calculation of the sample's refractive index.

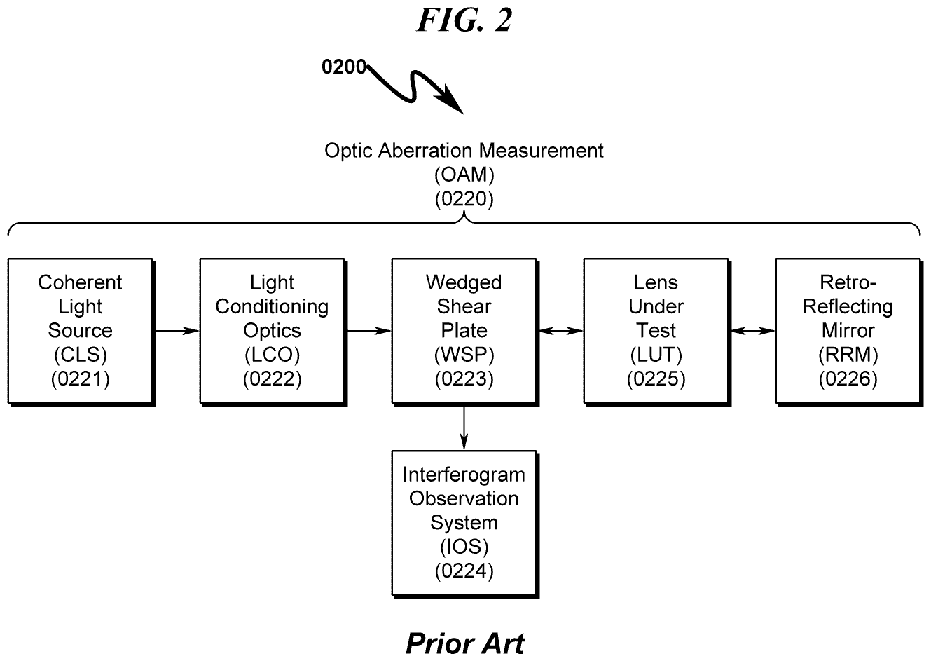

Interferometry can be used to characterize the aberrations of a wavefront of light after it is reflected off of reflective or passed through refractive optics. FIG. 2 (0200) depicts a block diagram of a prior art wedge shear plate system for optic aberration measurement (OAM). A coherent light source (0221) generates light that is conditioned by light conditioning optics (0222) in preparation for passing through a wedged shear plate (0223). The wave front then passes through a lens under test (0225), bounces off a retroreflective mirror (0226), and back through the lens under test. The retroreflected light then reflects off the wedged shear plate to an interferogram observation system (IOS) (0224). The resulting interferogram characterizes the aberrations, such as defocus, spherical, coma, astigmatism, etc.

### Dual-Use the Prior Art

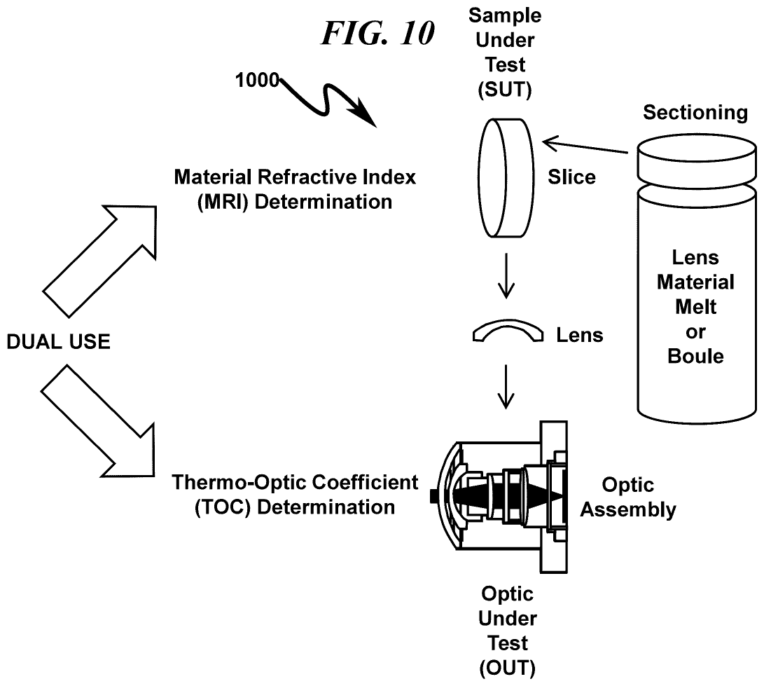

FIG. 10 (1000) depicts the dual use application of the present invention. In the production of refractive optics, lens materials are melted or boules grown to produce materials that transmit light in a desired wavelength. The refractive index of the material varies due to factors such as material processing parameters, chemical composition, and impurities. Currently, material is sectioned and then costly prisms must be fabricated to measure refractive index using the minimum deviation method. The present invention enables the sections to be polished into flat windows and directly tested for material refractive index (MRI) determination. Other sections of optic material are then ground and polished into lenses and used in an optic assembly. The present invention can also be used to measure the thermos-optic coefficient (TOC) of the optic assembly. Therefore, one single apparatus can be used to measure input lens materials and output optic performance.

The present invention solution has the following benefits:
(1) it uses flat sample geometries that are already made in the course of transmission testing,
(2) it enables analysis of high index materials,
(3) the measurement is fast and the method is simple,
(4) the footprint is much smaller, and
(5) the cost is drastically reduced compared to conventional methods.

Additionally, the simple one-sided measurement will allow for superior material temperature control which will drastically reduce the uncertainty when measuring materials like Ge with a high index dependence with temperature. Further, this same shear plate interferometric system has a dual use to measure thermal defocus on fully assembled optic systems. This greatly expands the utility of this system opening the market to many more potential applications.

### Relevant Past Work

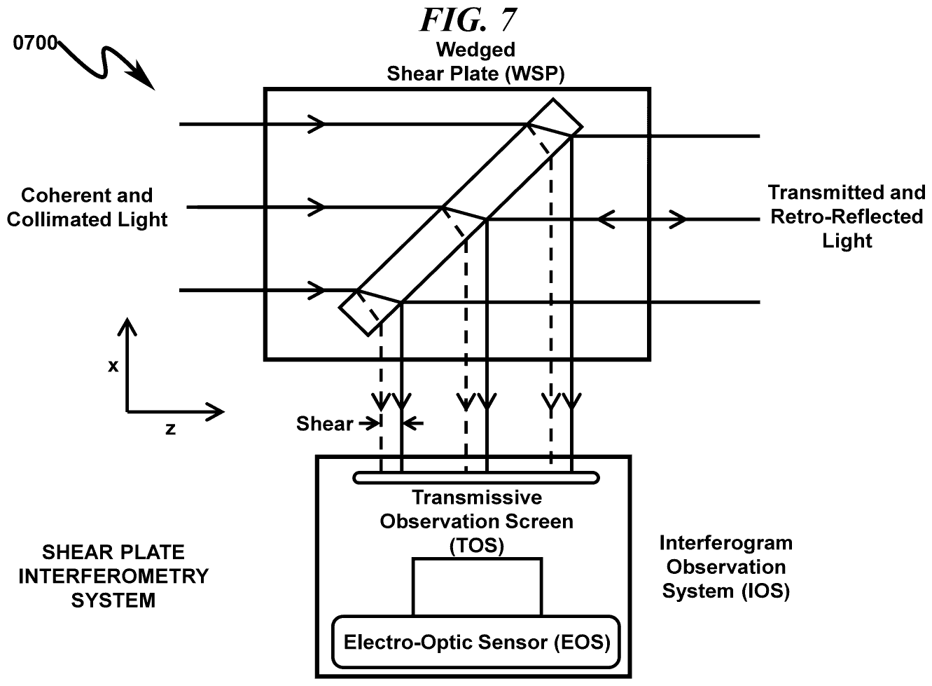

FIG. 7 (0700)-FIG. 10 (1000) depicts a wedged shear plate interferometer that augments and extends the FIG. 1 (0100) prior art diagram. The system measures thermal defocus and refractive index using a 632.8 nm HeNe laser source and a 0.001 mm resolution translation stage was used to accurately measure the refractive index of a 12 mm ZERODUR plate at 1.541; within +/−0.001 of Schott's published 1.5407 value in reference [4].

Applicant has demonstrated that the thermal defocus of a lens under test can be measured at the sub-micron level using this wedged shear plate interferometry method on an ALLVAR Alloy 30 athermalized doublet (reference [2]).

FIG. 7 (0700) depicts a specific embodiment of the wedged shear plate (WSP) and Interferogram Observation System (IOS). The WSP consists of a plate of transparent material at an angle to the incident coherent and collimated light. The wedge angle of the WSP produces horizontal lines in the interferogram when an aberration free wave front is reflected off the WSP front and back surfaces. The IOS consists of a transmissive observation screen (TOS) and an electro-optic sensor (EOS) that collect images of the interferogram. In another embodiment, a TOS can be replaced with a reflective observation screen and the projected interferogram imaged using an EOS.

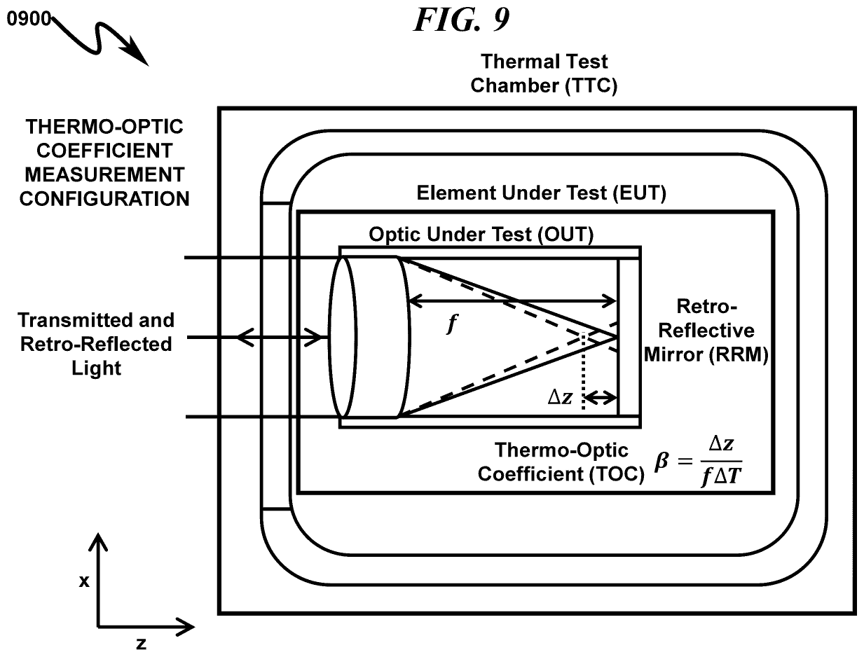

FIG. 8 (0800) depicts a graphic representation of the Thermal Test Chamber (TTC) configured for refractive index measurement. The light coming from the WSP enters the thermal test chamber and is focused on a sample using a removable optic assembly ROA. The ROA can be located inside or outside the TTC. The focused light is then retroreflected off the sample under test (SUT), back through the ROA and exits the TTC. By knowing the thickness of the SUT and the retroreflective conditions for the front and back surfaces of the SUT, the refractive index of the SUT can be calculated. FIG. 9 (0900) depicts a graphic representation of the Thermal Test Chamber (TTC) configured for determining a refractive optic's thermo-optic coefficient (TOC). The light coming from the WSP enters the thermal test chamber and is focused on a retroreflecting mirror (RRM). The focused light is then retroreflected off the RRM, back through the OUT and exits the TTC. The RRM is originally placed at the focal length of the optic under test (OUT) by the housing of the OUT. As the housing and lenses of the OUT change shape and refractive index with temperature, a separation between the OUT focus position and RRM occurs which is characterized by a difference in z-position, Δz. The Δz value is calculated using fringe analysis of the interferograms taken at different temperatures. By knowing the change in temperature, the original focal length of the OUT, f, and Δz, the thermo-optic coefficient of the OUT can be calculated.

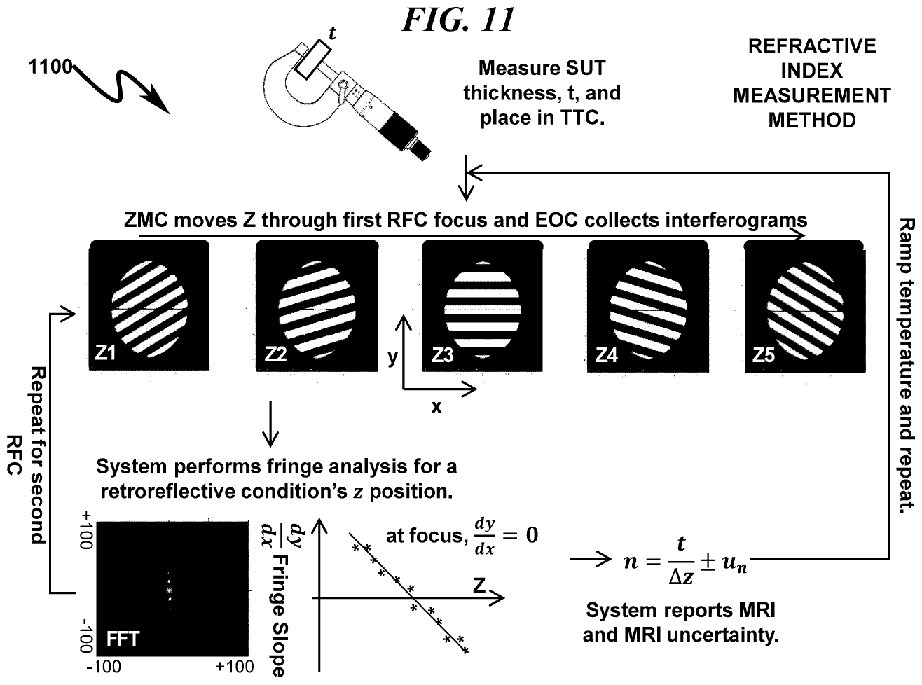

FIG. 11 (1100) depicts the interferogram analysis procedure for material refractive index (MRI) determination. First, the thickness, t, of a sample under test (SUT) is measured and the SUT is placed in the thermal test chamber (TTC). Multiple interferograms are collected as the z-position is stepped through the first retroreflective condition (RRC) associated with the front surface of the SUT, Z1 through Z5. Horizontal lines where the fringe slope is zero, such as those displayed at z-position 23, correspond to the at-focus z-position of the first RRC. These fringes are then analyzed using fringe fitting analysis (FFA) and fast Fourier transforms (FFT) to determine the z-position of the RRC. The process of z-position stepping and fringe analysis is repeated to determine the z-position for the second RRC. Then, having measured the SUT thickness, one can calculate the refractive index by dividing the SUT thickness by the z-position difference between the two RRC values. The change in refractive index with temperature is then determined by changing the temperature of the TTC and repeating the process.

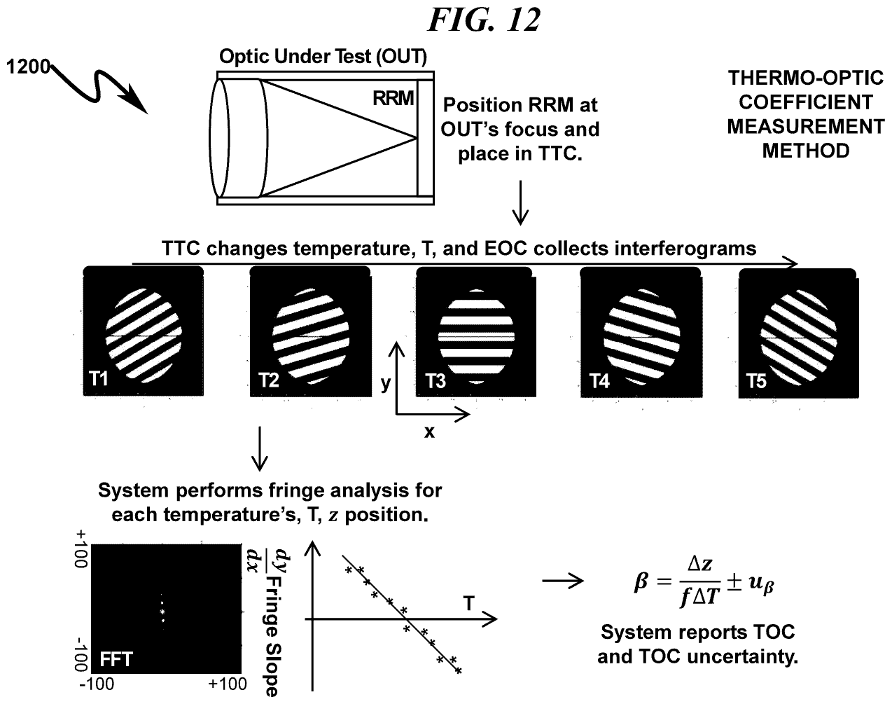

FIG. 12 (1200) depicts the interferogram analysis procedure for thermos-optic coefficient (TOC) determination. First, a retroreflective mirror (RRM) is placed at the focal length, f, of the optic under test (OUT) and the OUT is placed in the thermal test chamber (TTC). Multiple interferograms are collected as the TTC is stepped through various temperatures, T1 through T5. Horizontal lines where the fringe slope is zero, such as those displayed at T3, correspond to the at-focus of the first RRM. These fringes are then analyzed using fringe fitting analysis (FFA) and fast Fourier transforms (FFT) to determine the thermally induced change in z-position of the RRM compared to the OUT focal length, delta-z. Then, knowing the OUT focal length, one can calculate the TOC by dividing delta-z by the product of the focal length, f, and change in temperature, delta-T.

### Generalized Dual-Use Interferometer System (0300)-(0600

A preferred exemplary embodiment of the present invention method as depicted in FIG. 3 (0300)-FIG. 6 (0600) may be broadly generalized as a dual-use interferometer system comprising:
(a) coherent light source (CLS);
(b) light conditioning optics (LCO);
(c) wedged shear plate (WSP);
(d) interferogram observation system (IOS);
(e) removable optical assembly (ROA);
(f) element under test (EUT);
(g) thermal test chamber (TTC);
(h) digital computing device (DCD); and
(i) Z-motion control servomechanism (ZMC);
wherein:
said CLS generates light that is collimated, spatially filtered, and expanded by said LCO to form an LCO output light (LOL);
said LOL is passed through said WSP then through said ROA to said EUT;
said LOL is retroreflected back from said EUT through said ROA and reflected off said WSP to said IOS;
said LOL light reflected off said WSP is detected within said IOS by an electro-optic sensor (EOS);
said EUT is contained within said TTC; and
said DCD executes instructions retrieved from a tangible computer readable medium to implement a closed control loop (CCL) that operates to control the distance between said ROA and said EUT via actuation of said ZMC based on image data transferred from said EOS to said DCD.

One skilled in the art will recognize that this basic system may be augmented or rearranged in a variety of ways based on the needs of a specific application context.

### Shear Plate Interferometer Refractive Index Method (1300)

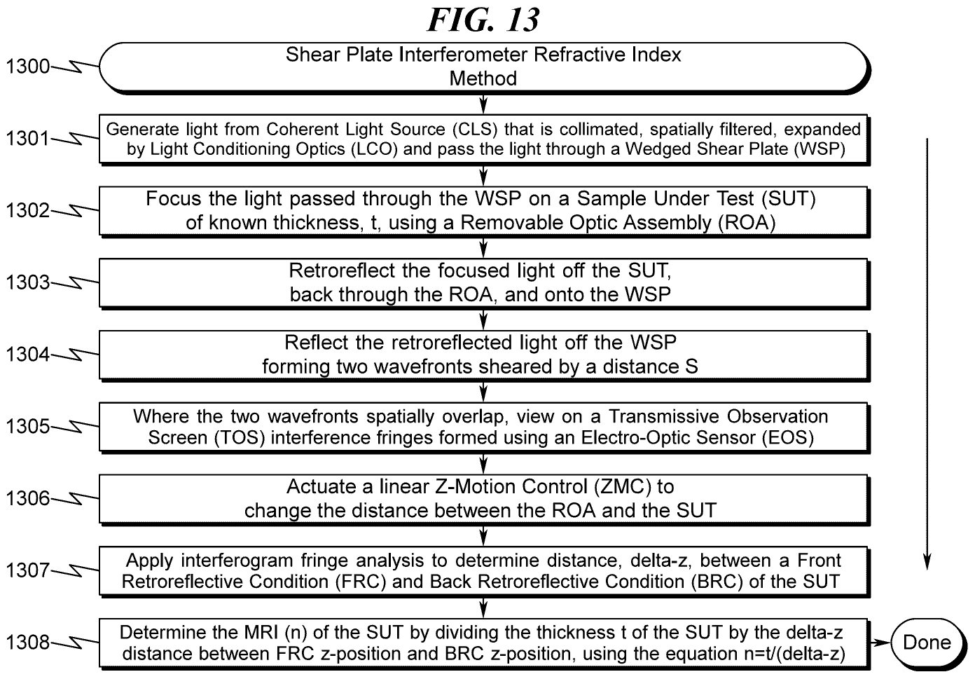

A preferred exemplary embodiment of the present invention method as depicted in FIG. 13 (1300) may be broadly generalized as a shear plate interferometer refractive index method comprising:
(1) generating light from a Coherent Light Source (CLS) that is collimated, spatially filtered, and expanded by Light Conditioning Optics (LCO) and passing the light through a Wedged Shear Plate (WSP) (1301);
(2) focusing the light passed through the WSP on a Sample Under Test (SUT) of known thickness, t, using a Removable Optic Assembly (ROA) (1302);
(3) retroreflecting the focused light off the SUT, back through the ROA, and onto the WSP (1303);
(4) reflecting the retroreflected light off the WSP forming two wavefronts sheared by a distance S (1304);
(5) where the two wavefronts spatially overlap, viewing on a Transmissive Observation Screen (TOS) interference fringes formed using an electro-optic sensor (EOS) (1305);
(6) actuating a linear Z-Motion Control (ZMC) to change the distance between the ROA and the SUT (1306);
(7) applying interferogram fringe analysis to determine distance, delta-z, between a Front Retroreflective Condition (FRC) and Back Retroreflective Condition (BRC) of the SUT (1307); and
(8) determining the MRI (n) of the SUT by dividing the thickness t of the SUT by the delta-z distance between the FRC z-position and the BRC z-position, using the equation n=t/(delta-z).
   This general system may be modified heavily depending on a number of factors, with rearrangement and/or addition/deletion of functions anticipated by the scope of the present invention. Integration of this and other preferred exemplary embodiment systems described herein is anticipated by the overall scope of the present invention.

### Interferometer Refractive Index Method (1400)

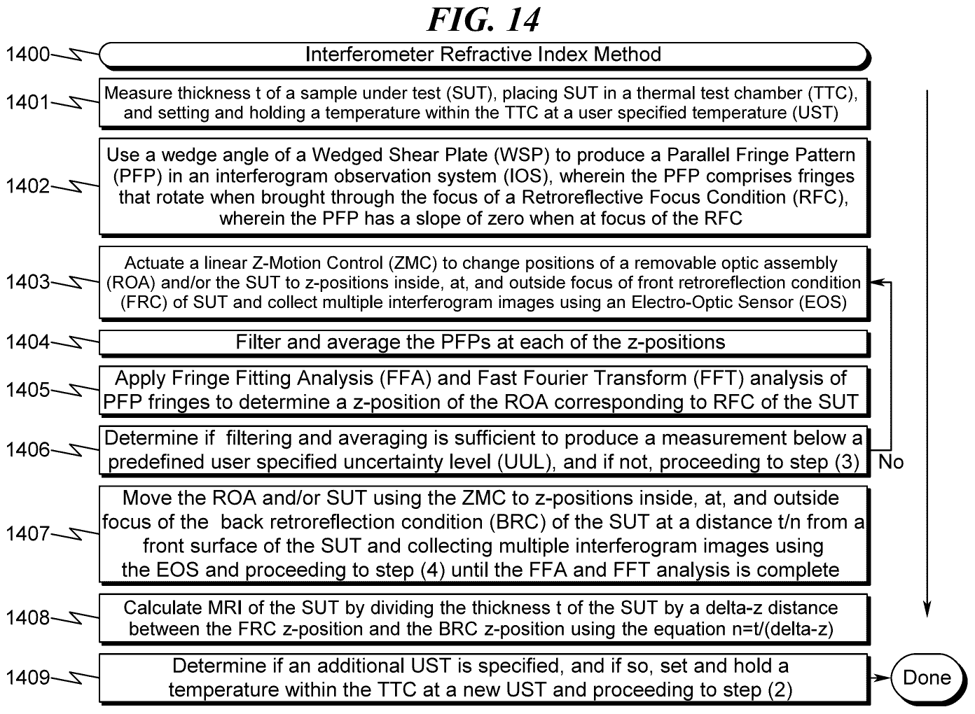

A preferred exemplary embodiment of the present invention method as depicted in FIG. 14 (1400) may be broadly generalized as an interferometer refractive index method comprising:
(1) measuring thickness t of a sample under test (SUT), placing the SUT in a thermal test chamber (TTC), and setting and holding a temperature within the TTC at a user specified temperature (UST) (1401);
(2) using a wedge angle of a Wedged Shear Plate (WSP) to produce a Parallel Fringe Pattern (PFP) in an interferogram observation system (IOS), wherein the PFP comprises fringes that rotate when brought through the focus of a Retroreflective Focus Condition (RFC), wherein the PFP has a slope of zero when at focus of the RFC (1402);
(3) actuating a linear Z-Motion Control (ZMC) to change positions of a removable optic assembly (ROA) and/or the SUT to z-positions inside, at, and outside focus of front retroreflection condition (FRC) of the SUT and collecting multiple interferogram images using an electro-optic sensor (EOS) (1403);
(4) filtering and averaging the PFPs at each of the z-positions (1404);
(5) applying Fringe Fitting Analysis (FFA) and Fast Fourier Transform (FFT) analysis of the PFP fringes to determine a z-position of the ROA corresponding to the RFC of the SUT (1405);
(6) determining if the filtering and averaging is sufficient to produce a measurement below a predefined user specified uncertainty level (UUL), and if not, proceeding to step (3) (1406);
(7) moving the ROA and/or SUT using the ZMC to z-positions inside, at, and outside focus of the back retroreflection condition (BRC) of the SUT at a distance t/n from a front surface of the SUT and collecting multiple interferogram images using the EOS and proceeding to step (4) until the FFA and FFT analysis is complete (1407);
(8) calculating the MRI of the SUT by dividing the thickness t of the SUT by a delta-z distance between the FRC z-position and the BRC z-position using the equation n=t/(delta-z) (1408); and
(9) determining if an additional UST is specified, and if so, setting and holding a temperature within the TTC at a new UST and proceeding to step (2) (1409).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Shear Plate Interferometer Thermal Defocus Method (1500)

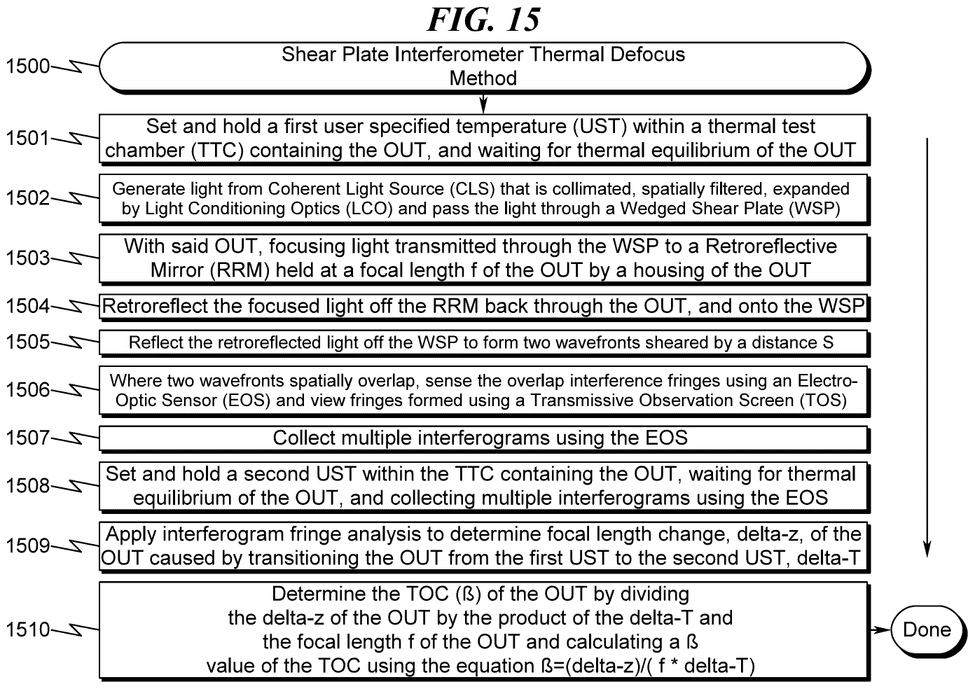

A preferred exemplary embodiment of the present invention method as depicted in FIG. 15 (1500) may be broadly generalized as a shear plate interferometer thermal defocus method comprising:
(1) setting and holding a first user specified temperature (UST) within a thermal test chamber (TTC) containing the OUT, and waiting for thermal equilibrium of the OUT (1501);
(2) generating light from a Coherent Light Source (CLS) that is collimated, spatially filtered, and expanded by Light Conditioning Optics (LCO) and passing the light through a Wedged Shear Plate (WSP) (1502);
(3) with said OUT, focusing light transmitted through the WSP to a Retroreflective Mirror (RRM) held at a focal length f of the OUT by a housing of the OUT (1503);
(4) retroreflecting the focused light off the RRM back through the OUT, and onto the WSP (1504);
(5) reflecting the retroreflected light off the WSP to form two wavefronts sheared by a distance S (1505);
(6) where the two wavefronts spatially overlap, sensing the overlap interference fringes using an electro-optic sensor (EOS) and viewing the fringes formed using a Transmissive Observation Screen (TOS) (1506);
(7) collecting multiple interferograms using the EOS (1507);
(8) setting and holding a second UST within the TTC containing the OUT, waiting for thermal equilibrium of the OUT, and collecting multiple interferograms using the EOS (1508);
(9) applying interferogram fringe analysis to determine focal length change, delta-z, of the OUT caused by transitioning the OUT from the first UST to the second UST, delta-T (1509); and
(10) determining the TOC (ß) of the OUT by dividing the delta-z of the OUT by the product of the delta-T and the focal length f of the OUT and calculating a ß value of the TOC using the equation ß=(delta-z)/(f*delta-T) (1510).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Interferometer Thermal Defocus Method (1600)

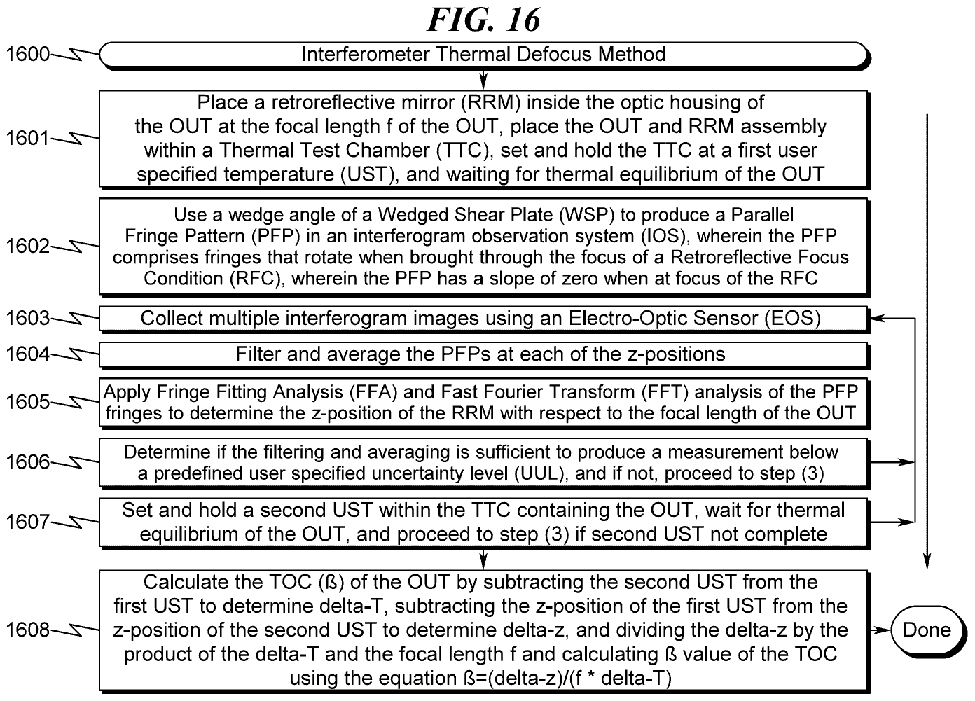

A preferred exemplary embodiment of the present invention method as depicted in FIG. 16 (1600) may be broadly generalized as an interferometer thermal defocus method comprising:
(1) placing a retroreflective mirror (RRM) inside the optic housing of the OUT at the focal length f of the OUT, placing the OUT and RRM assembly within a Thermal Test Chamber (TTC), setting and holding the TTC at a first user specified temperature (UST), and waiting for thermal equilibrium of the OUT (1601);
(2) using a wedge angle of a Wedged Shear Plate (WSP) to produce a Parallel Fringe Pattern (PFP) in an interferogram observation system (IOS), wherein the PFP comprises fringes that rotate when brought through the focus of a Retroreflective Focus Condition (RFC), wherein the PFP has a slope of zero when at focus of the RFC (1602);
(3) collecting multiple interferogram images using an electro-optic sensor (EOS) (1603);
(4) filtering and averaging the PFPs at each of the z-positions (1604);
(5) applying Fringe Fitting Analysis (FFA) and Fast Fourier Transform (FFT) analysis of the PFP fringes to determine the z-position of the RRM with respect to the focal length of the OUT (1605);
(6) determining if the filtering and averaging is sufficient to produce a measurement below a predefined user specified uncertainty level (UUL), and if not, proceeding to step (3) (1606);
(7) setting and holding a second UST within the TTC containing the OUT, waiting for thermal equilibrium of the OUT, and proceeding to step (3) (1607);
(8) calculating the TOC (B) of the OUT by subtracting the second UST from the first UST to determine delta-T, subtracting the z-position of the first UST from the z-position of the second UST to determine delta-z, and dividing the delta-z by the product of the delta-T and the focal length f and calculating ß value of the TOC using the equation ß=(delta-z)/(f*delta-T) (1608).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

It should be noted that the DCD may operate to spatially separate the system components using Z-motion control servomechanism (ZMC) in a variety of ways. In some circumstances certain components may be fixed while others are movable.

The DCD generally will be configured to accept image data from the EOS contained within the IOS and use this data to control the ZMC to focus images, detect fringes, etc. The DCD may also be configured to control the temperature environment of the EUT using the TTC.

One skilled in the art will recognize that other embodiments are possible based on combinations of elements taught within the above invention description.

### CONCLUSION

An interferometer system and method capable of simultaneous refractive index and thermal defocus determination has been disclosed. The system incorporates a collimating light that is spatially filtered, and expanded, and passed through a wedged shear plate and focused on a sample of known thickness. The focused light is retroreflected through the focusing optic, and reflected off the shear plate. The retroreflected light is reflected off the wedged shear plate forming two wavefronts. Where the two wavefronts spatially overlap, an observation screen is used to view the interference fringes formed. The focus optic is translated on a linear stage and the interferogram is used to determine the retroreflective condition for both the front and back surfaces of the sample. The system/method may be advantageously applied to a wide variety of optical lens materials, including but not limited to the characterization of infrared (IR) lens materials.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112(f) and such claim shall be construed to cover the corresponding structure, material, or acts described in the specification and equivalents thereof.
The phrase “MEANS FOR” specifically invokes the means-plus-function claims limitation recited in 35 U.S.C. § 112(f) and such claim shall be construed to cover the corresponding structure, material, or acts described in the specification and equivalents thereof.
The phrase “STEP FOR” specifically invokes the step-plus-function claims limitation recited in 35 U.S.C. § 112(f) and such claim shall be construed to cover the corresponding structure, material, or acts described in the specification and equivalents thereof.
The step-plus-function claims limitation recited in 35 U.S.C. § 112(f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”)
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

Although a preferred embodiment of the present invention has been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A dual-use interferometer system comprising:
(a) coherent light source (CLS);
(b) light conditioning optics (LCO);
(c) wedged shear plate (WSP);
(d) interferogram observation system (IOS);
(e) removable optical assembly (ROA);
(f) element under test (EUT);
(g) thermal test chamber (TTC);
(h) digital computing device (DCD); and
(i) Z-motion control servomechanism (ZMC);
wherein:
said CLS generates light that is collimated, spatially filtered, and expanded by said LCO to form an LCO output light (LOL);
said LOL is passed through said WSP then through said ROA to said EUT;
said LOL is retroreflected back from said EUT through said ROA and reflected off said WSP to said IOS;
said LOL light reflected off said WSP is detected within said IOS by an electro-optic sensor (EOS);
said EUT is contained within said TTC; and
said DCD executes instructions retrieved from a tangible computer readable medium to implement a closed control loop (CCL) that operates to control the distance between said ROA and said EVER EUT via actuation of said ZMC based on image data transferred from said EOS to said DCD.

2. The system of claim 1 wherein:
said ZMC actuation controls the position of said ROA; and
said ZMC actuation controls the position of said EUT.

3. The system of claim 1 wherein:
said ROA has a fixed position; and
said ZMC actuation controls the position of said EUT.

4. The system of claim 1 wherein:
said ZMC actuation controls the position of said ROA; and
said EUT has a fixed position.

5. The system of claim 1 wherein said CCL controls the temperature within said TTC.

6. Material Refractive Index (MRI), said method comprising:
(1) generating light from a Coherent Light Source (CLS) that is collimated, spatially filtered, and expanded by Light Conditioning Optics (LCO) and passing said light through a Wedged Shear Plate (WSP) (1301);
(2) focusing said light passed through said WSP on a Sample Under Test (SUT) of known thickness, t, using a Removable Optic Assembly (ROA) (1302);
(3) retroreflecting said focused light off said SUT, back through said ROA, and onto said WSP (1303);
(4) reflecting said retroreflected light off said WSP forming two wavefronts sheared by a distance S (1304);
(5) where said two wavefronts spatially overlap, viewing on a Transmissive Observation Screen (TOS) interference fringes formed using an electro-optic sensor (EOS) (1305);
(6) actuating a linear Z-Motion Control (ZMC) to change the distance between said ROA and said SUT (1306);
(7) applying interferogram fringe analysis to determine distance, delta-z, between a Front Retroreflective Condition (FRC) and Back Retroreflective Condition (BRC) of said SUT (1307); and
(8) determining said MRI (n) of said SUT by dividing said thickness t of said SUT by said delta-z distance between said FRC z-position and said BRC z-position, using the equation n=t/(delta-z).

7. The method of claim 6 wherein:
said ZMC is actuated by a closed control loop (CCL) operating on a digital computing device (DCD) that executes instructions read from a tangible computer readable media;
said ZMC actuation controls the position of said ROA; and
said ZMC actuation controls the position of said SUT.

8. The method of claim 6 wherein:
said ZMC is actuated by a closed control loop (CCL) operating on a digital computing device (DCD) that executes instructions read from a tangible computer readable media;
said ROA has a fixed position; and
said ZMC actuation controls the position of said SUT.

9. The method of claim 6 wherein:
said ZMC is actuated by a closed control loop (CCL) operating on a digital computing device (DCD) that executes instructions read from a tangible computer readable media;
said ZMC actuation controls the position of said ROA; and
said SUT has a fixed position.

10. The method of claim 6 wherein:
said ZMC is actuated by a closed control loop (CCL) operating on a digital computing device (DCD) that executes instructions read from a tangible computer readable media;
said CCL retrieves image data from said EOS and uses this data to control the distance between said ROA and said SUT; and
said CCL applies said interferogram fringe analysis to graphical input from said EOS to determine said delta-z distance.

11. A shear plate interferometer method for measuring Material Refractive Index (MRI), said method comprising:
(1) measuring thickness t of a sample under test (SUT), placing said SUT in a thermal test chamber (TTC), and setting and holding a temperature within said TTC at a user specified temperature (UST) (1401);
(2) using a wedge angle of a Wedged Shear Plate (WSP) to produce a Parallel Fringe Pattern (PFP) in an interferogram observation system (IOS), wherein said PFP comprises fringes that rotate when brought through the focus of a Retroreflective Focus Condition (RFC), wherein said PFP has a slope of zero when at focus of said RFC (1402);
(3) actuating a linear Z-Motion Control (ZMC) to change positions of a removable optic assembly (ROA) and/or said SUT to z-positions inside, at, and outside focus of front retroreflection condition (FRC) of said SUT and collecting multiple interferogram images using an electro-optic sensor (EOS) (1403);
(4) filtering and averaging said PFPs at each of said z-positions (1404);
(5) applying Fringe Fitting Analysis (FFA) and Fast Fourier Transform (FFT) analysis of said PFP fringes to determine a z-position of said ROA corresponding to said RFC of said SUT (1405);
(6) determining if said filtering and averaging is sufficient to produce a measurement below a predefined user specified uncertainty level (UUL), and if not, proceeding to step (3) (1406);
(7) moving the ROA and/or SUT using the ZMC to z-positions inside, at, and outside focus of said back retroreflection condition (BRC) of said SUT at a distance t/n from a front surface of said and SUT collecting multiple interferogram images using said EOS and proceeding to step (4) until said FFA and FFT analysis is complete (1407);
(8) calculating said MRI of said SUT by dividing said thickness t of said SUT by a delta-z distance between said FRC z-position and said BRC z-position using the equation n=t/(delta-z) (1408); and
(9) determining if an additional UST is specified, and if so, setting and holding a temperature within said TTC at a new UST and proceeding to step (2) (1409).

12. The method of claim 11 wherein:
said ZMC is actuated by a closed control loop (CCL) operating on a digital computing device (DCD) that executes instructions read from a tangible computer readable media;
said ZMC actuation controls the position of said ROA; and
said ZMC actuation controls the position of said SUT.

13. The method of claim 11 wherein:
said ZMC is actuated by a closed control loop (CCL) operating on a digital computing device (DCD) that executes instructions read from a tangible computer readable media;
said ROA has a fixed position; and
said ZMC actuation controls the position of said SUT.

14. The method of claim 11 wherein:
said ZMC is actuated by a closed control loop (CCL) operating on a digital computing device (DCD) that executes instructions read from a tangible computer readable media;
said ZMC actuation controls the position of said ROA; and
said SUT has a fixed position.

15. The method of claim 11 wherein:
said ZMC is actuated by a closed control loop (CCL) operating on a digital computing device (DCD) that executes instructions read from a tangible computer readable media;
said CCL retrieves image data from said EOS and uses this data to control the distance between said ROA and said SUT; and
said CCL modulates the temperature of said UST in response to image data from said EOS.

16. A shear plate interferometer method for measuring a Thermo-Optic Coefficient (TOC) of an Optic Under Test (OUT), said method comprising:
(1) setting and holding a first user specified temperature (UST) within a thermal test chamber (TTC) containing said OUT, and waiting for thermal equilibrium of said OUT (1501);
(1) generating light from a Coherent Light Source (CLS) that is collimated, spatially filtered, and expanded by Light Conditioning Optics (LCO) and passing said light through a Wedged Shear Plate (WSP) (1502);
(2) with said OUT, focusing light transmitted through said WSP to a Retroreflective Mirror (RRM) held at a focal length f of said OUT by a housing of said OUT (1503);
(3) retroreflecting said focused light off said RRM back through said OUT, and onto said WSP (1504);
(4) reflecting said retroreflected light off said WSP to form two wavefronts sheared by a distance S (1505);
(5) where said two wavefronts spatially overlap, sensing said overlap interference fringes using an electro-optic sensor (EOS) and viewing said fringes formed using a Transmissive Observation Screen (TOS) (1506);
(6) collecting multiple interferograms using said EOS (1507);
(7) setting and holding a second UST within said TTC containing said OUT, waiting for thermal equilibrium of said OUT, and collecting multiple interferograms using said EOS (1508);
(8) applying interferogram fringe analysis to determine focal length change, delta-z, of said OUT caused by transitioning said OUT from said first UST to said second UST, delta-T (1509); and
(9) determining said TOC (B) of said OUT by dividing said delta-z of said OUT by the product of said delta-T and said focal length f of said OUT and calculating a ß value of said TOC using the equation ß=(delta-z)/(f*delta-T) (1510).

17. The system of claim 16 wherein a closed control loop (CCL) controls the temperature within said TTC.

18. The system of claim 16 wherein a closed control loop (CCL) modulates the temperature of said OUT in response to image data from said EOS.

19. A shear plate interferometer method for measuring a Thermo-Optic Coefficient (TOC) of an Optic Under Test (OUT), said method comprising:
(1) placing a retroreflective mirror (RRM) inside the optic housing of said OUT at the focal length f of said OUT, placing said OUT and RRM assembly within a Thermal Test Chamber (TTC), setting and holding said TTC at a first user specified temperature (UST), and waiting for thermal equilibrium of said OUT (1601);
(2) using a wedge angle of a Wedged Shear Plate (WSP) to produce a Parallel Fringe Pattern (PFP) in an interferogram observation system (IOS), wherein said PFP comprises fringes that rotate when brought through the focus of a Retroreflective Focus Condition (RFC), wherein said PFP has a slope of zero when at focus of said RFC (1602);
(3) collecting multiple interferogram images using an electro-optic sensor (EOS) (1603);
(4) filtering and averaging said PFPs at each of said z-positions (1604);
(5) applying Fringe Fitting Analysis (FFA) and Fast Fourier Transform (FFT) analysis of said PFP fringes to determine the z-position of said RRM with respect to said focal length of said OUT (1605);
(6) determining if said filtering and averaging is sufficient to produce a measurement below a predefined user specified uncertainty level (UUL), and if not, proceeding to step (3) (1606);
(7) setting and holding a second UST within said TTC containing said OUT, waiting for thermal equilibrium of said OUT, and proceeding to step (3) (1607);
(8) calculating said TOC (B) of said OUT by subtracting said second UST from said first UST to determine delta-T, subtracting said z-position of said first UST from said z-position of said second UST to determine delta-z, and dividing said delta-z by the product of said delta-T and said focal length f and calculating ß value of said TOC using the equation ß=(delta-z)/(f*delta-T) (1608).

20. The system of claim 19 wherein a closed control loop (CCL) controls the temperature within said TTC.

21. The system of claim 19 wherein a closed control loop (CCL) modulates the temperature of said OUT in response to image data from said EOS.
